(19) United States
(12) Patent Application Publication
(10) Pub. No.: US 2004/0010404 A1
(43) Pub. Date: Jan. 15, 2004

(54) Method for replacing language of user interface without having to restart application

(76) Inventors: Stone Cheng, Kaohsiung (TW); Shih-Wen Chen, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,385

(22) Filed: Jul. 9, 2002

(51) Int. Cl. G06F 17/20

(52) U.S. Cl. 704/8

(57) ABSTRACT

The present invention provides a method for replacing the language of the user interface without having to restart the application. The method is used to replace the language of the user interface in the same set of the computer. When user chooses a desired language, the corresponding external language file is searched at first. The corresponding language string is subsequently searched. Afterwards, the language replacement is completed and the desired language is displayed on the user interface by directly redrawing the user interface without having to close the application. The present invention allows users to choose and replace the user interface of different language per their preference. Moreover, the new language can be displayed on the user interface without having to restart the application. Therefore, the present invention truly provides the feature of multiple languages can be used selectively in the same user interface.

### BACKGROUND OF INVENTION

1. Field of Invention

The present invention generally relates to a method for replacing the language of the user interface, and more particularly, to a method for replacing the language of the user interface without having to restart the application.

2. Description of Related Art

Most of the software user interfaces used previously only supported one language. Although the software user interfaces used currently support multiple languages that the user can choose from, in order to replace the language of the user interface, the application needs to be turned off and restarted again. Such a method is very inconvenient for multiple users using the same set of computer. For example, when a user who is skilled in Chinese and English uses a set of software on the same computer where the Windows 2000 or Windows XP Chinese version operating system is running, generally the software user interface is represented in Chinese. However, if the user who is only skilled in English would like to use this software user interface with Chinese language, the difficulty of using this set of software is generated since he/she cannot understand the software user interface with this language. At the moment, if the user who only skilled in English would like to change the language of the software user interface back to the English, since the related dynamic link library (DLL) needs to be restarted when the language internal code of the user interface of the Windows 2000 or Windows XP is intended to be replaced. Therefore, the Windows 2000 or Windows XP needs to be turned off first and restarted again, so as to the related dynamic link library can be loaded to replace the software user interface with English language, it is very inconvenient to the user who only skilled in English.

### SUMMARY OF INVENTION

The present invention provides a method for replacing the language of the user interface without having to restart the application. The present invention allows users to choose and replace the user interface of different language per their preference. Moreover, the new language can be displayed on the user interface without having to restart the application. So as to the multiple installations or restarting of the application can be avoided when user has different language preference.

In order to achieve the objectives mentioned above and others, the present invention provides a method for replacing the language of the user interface without having to restart the application. The method is used to replace the language of the user interface in the same computer. When user chooses a desired language, the corresponding external language file is searched at first. The corresponding language string is subsequently searched. Afterwards, the language replacement is completed and the desired language is displayed on the user interface by directly redrawing the user interface without having to close the application.

In a preferred embodiment of the present invention, the step of directly redrawing the user interface without having to close the application is to redraw the user interface of the original language with the user interface of the desired language.

In a preferred embodiment of the present invention, the language string can be modified to comply with the desired language when there is no language string corresponding to the desired language.

In a preferred embodiment of the present invention, the external language file can be modified to comply with the desired language when there is no external language file corresponding to the desired language.

In a preferred embodiment of the present invention, the language comprises a variety of languages.

In a preferred embodiment of the present invention, the language string comprises a variety of language strings.

In a preferred embodiment of the present invention, the external language file comprises a variety of external language files.

In a preferred embodiment of the present invention, the application is operated in the operating system, wherein the operating system comprises a variety of operating systems.

In summary, the present invention allows users to choose and replace the user interface to a different language per their preference. Moreover, the new language can be displayed on the user interface without having to restart the application. Multiple installations or restarting of the application can be avoided when the user has a different language preference. Therefore, the present invention truly provides the feature of multiple languages can be used selectively in the same user interface.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a flow chart of a method for replacing the language of the user interface without having to restart the application of a preferred embodiment according to the present invention.

### DETAILED DESCRIPTION

The present invention mainly allows multiple users to use the same set of software conveniently in the same set of computers. For example, when a user who is skilled in Chinese and English uses a set of software in the same computer where the Windows 2000 or Windows XP Chinese version operating system is running, generally the software user interface is represented in Chinese. However, if the user who is only skilled in English would like to use this software user interface with Chinese language, the difficulty of using this set of software is generated since he/she cannot understand the software user interface with this language. At the moment, if the user who only skilled in English would like to change the language of the software user interface back to the English, it only has to execute the application provided by the present invention on the Windows 2000 or Windows XP Chinese version operating system, so as to the language of the user interface can be replaced in real time without having to restart the application. Therefore, it is more convenient for user to use it.

The technical principle of the method for replacing the language of the user interface without having to restart the application according to the present invention is as follows, after the application is executed, if users like to replace the language of the user interface with their own preference, the application searches the corresponding external language file besides the original language chosen by the user, and also searches the corresponding language string in the external language file, afterwards, redraws the user interface, so as to the language of the user interface can be replaced directly.

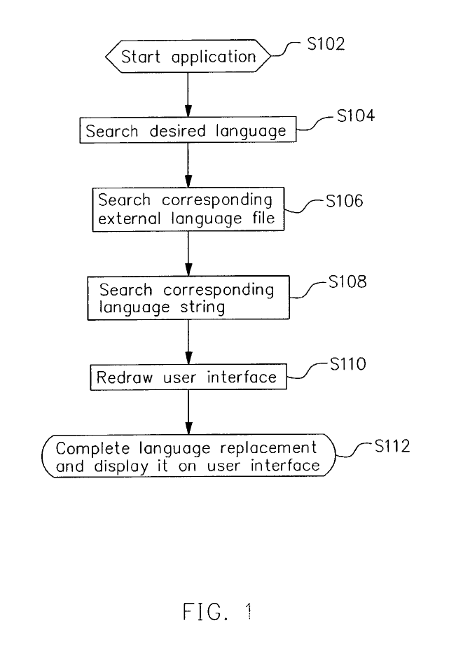

Please refer to FIG. 1, it schematically shows a flow chart of a method for replacing the language of the user interface without having to restart the application of a preferred embodiment according to the present invention. The method is used to replace the language of the user interface in the same set of the computer. After the application is started (as step s102), when user chooses a desired language (as step s104), the corresponding external language file is searched at first (as step s106). The corresponding language string (the extended file named as log) is subsequently searched (as step s108). Afterwards, the language replacement is completed and the desired language is displayed on the user interface (as step s112) by directly redrawing the user interface without having to close the application (as step s100).

In the present preferred embodiment, it is not necessary to close and restart the application after the corresponding language string is searched according to the present invention, thus it is more convenient for user to use it. The step of directly redrawing the user interface without having to close the application (as step s110) is to redraw the user interface of the original language with the user interface of the desired language.

In the present preferred embodiment, the language string can be modified to comply with the desired language when there is no language string corresponded to the desired language. For example, when user chooses Latin language, the Latin string can be added into the original language string to fulfill user requirement if the corresponding Latin string cannot be found.

In the present preferred embodiment, the external language file can be modified to comply with the desired language when there is no external language file corresponded to the desired language. For example, when user chooses French language, the French external language file can be added into the original external language file to fulfill user requirement if the corresponding French external language file cannot be found.

Moreover, in the present preferred embodiment, the application of the present invention can be operated on a variety of the operating systems or platforms, such as Windows 98, Windows NT, Windows 2000, Windows XP, Macintosh, or Novell.

Furthermore, in the present preferred embodiment, the language provided to user for replacement comprises a variety of languages. Similarly, the language string comprises a variety of language strings. Moreover, the external language file also may comprise a variety of external language files.

In summary, the present invention allows users to choose and replace the user interface of different language per their preference. Moreover, the new language can be displayed on the user interface without having to restart the application. So as to the multiple installations or restarting of the application can be avoided when user has different language preference. Therefore, the present invention truly provides the feature of multiple languages can be used selectively in the same user interface.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for replacing a language of a user interface without having to restart an application, used to replace the language of the user interface in the same set of computer, comprising:
choosing a desired language;
searching a corresponding external language file;
searching a corresponding language string; and
directly redrawing the user interface without having to close the application.

2. The method of claim 1, wherein the step of directly redrawing the user interface without having to close the application is to redraw the user interface of the original language with the user interface of the desired language.

3. The method of claim 1, wherein the language string can be modified to comply with the desired language when there is no language string corresponded to the desired language.

4. The method of claim 1, wherein the external language file can be modified to comply with the desired language when there is no external language file corresponded to the desired language.

5. The method of claim 1, wherein the language comprises a variety of languages.

6. The method of claim 1, wherein the language string comprises a variety of language strings.

7. The method of claim 1, wherein the external language file comprises a variety of external language files.

8. The method of claim 1, wherein the application is operated on an operating system.

9. The method of claim 7, wherein the operating system comprises a variety of operating systems.
